(19) United States
(12) Patent Application Publication
(10) Pub. No.: US 2009/0181281 A1
(43) Pub. Date: Jul. 16, 2009

(54) ELECTROCHEMICAL CELL BIPOLAR PLATE

(75) Inventors: Benjamin M. Piecuch, Meriden, CT (US); Blake D. Carter, Norwalk, CT (US); Luke T. Dalton, Middletown, CT (US); Jacob Friedman, Storrs, CT (US)

Correspondence Address: CANTOR COLBURN, LLP - PROTON, 20 Church Street, 22nd Floor, Hartford, CT, 06103, US

(73) Assignee: PROTON ENERGY SYSTEMS, INC., Wallingford, CT (US)

(21) Appl. No.: 12/013,837

(22) Filed: Jan. 14, 2008

(51) Int. Cl. H01M 4/00; H01M 6/48; H01M 8/10

(52) U.S. Cl. 429/34; 429/210

(57) ABSTRACT

A bipolar plate for an electrochemical cell is disclosed. The bipolar plate includes a unitary plate having first and second inlet ports, first and second outlet ports. The bipolar plate further includes a plurality of protrusions on each surface that forms a first plurality of flow channels, and second plurality flow channels. A first frame inlet header channel at one end of the first flow channels is in fluid communication with the first inlet port, and a first outlet header channel at the other end of the first flow channels is in fluid communication with the first outlet port. A second frame inlet header channel at one end of the second flow channels is in fluid communication with the second inlet port, and an outlet header channel at the other end of the second flow channels is in fluid communication with the second outlet port. Each of the header channels provides a fluid flow channel from one end of the respective header channel to the other end.

### STATEMENT REGARDING FEDERALLY SPONSORED RESEARCH

Certain aspects of the disclosed embodiments were made with Government support under contract HQ0006-03-C-0142 awarded by the United States Missile Defense Agency. The Government may have certain rights in the invention.

### BACKGROUND OF INVENTION

The present disclosure relates generally to electrochemical cells, and particularly to electrochemical cells having a bipolar plate.

Electrochemical cells are energy conversion devices, usually classified as either electrolysis cells or fuel cells. A proton exchange membrane electrolysis cell can function as a hydrogen generator by electrolytically decomposing water to produce hydrogen and oxygen gas, and can function as a fuel cell by electrochemically reacting hydrogen with oxygen to generate electricity. Referring to FIG. 1, which is a partial section of a typical anode feed electrolysis cell 100, process water 102 is fed into cell 100 on the side of an oxygen electrode (anode) 116 to form oxygen gas 104, electrons, and hydrogen ions (protons) 106. The reaction is facilitated by the positive terminal of a power source 120 electrically connected to anode 116 and the negative terminal of power source 120 connected to a hydrogen electrode (cathode) 114. The oxygen gas 104 and a portion of the process water 108 exits cell 100, while protons 106 and water 110 migrate across a proton exchange membrane 118 to cathode 114 where hydrogen gas 112 is formed.

Another typical water electrolysis cell using the same configuration as is shown in FIG. 1 is a cathode feed cell, wherein process water is fed on the side of the hydrogen electrode. A portion of the water migrates from the cathode across the membrane to the anode where hydrogen ions and oxygen gas are formed due to the reaction facilitated by connection with a power source across the anode and cathode. A portion of the process water exits the cell at the cathode side without passing through the membrane.

A typical fuel cell uses the same general configuration as is shown in FIG. 1. Hydrogen gas is introduced to the hydrogen electrode (the anode in fuel cells), while oxygen, or an oxygen-containing gas such as air, is introduced to the oxygen electrode (the cathode in fuel cells). Water can also be introduced with the feed gas. The hydrogen gas for fuel cell operation can originate from a pure hydrogen source, hydrocarbon, methanol, or any other hydrogen source that supplies hydrogen at a purity suitable for fuel cell operation (i.e., a purity that does not poison the catalyst or interfere with cell operation). Hydrogen gas electrochemically reacts at the anode to produce protons and electrons, wherein the electrons flow from the anode through an electrically connected external load, and the protons migrate through the membrane to the cathode. At the cathode, the protons and electrons react with oxygen to form water, which additionally includes any feed water that is dragged through the membrane to the cathode. The electrical potential across the anode and the cathode can be exploited to power an external load.

In other embodiments, one or more electrochemical cells may be used within a system to both electrolyze water to produce hydrogen and oxygen, and to produce electricity by converting hydrogen and oxygen back into water as needed. Such systems are commonly referred to as regenerative fuel cell systems.

Electrochemical cell systems typically include a number of individual cells arranged in a stack, with the working fluids directed through the cells via input and output conduits or ports formed within the stack structure. The cells within the stack are sequentially arranged, each including a cathode, a proton exchange membrane, and an anode. The cathode and anode may be separate layers or may be integrally arranged with the membrane. Each cathode/membrane/anode assembly (hereinafter “membrane-electrode-assembly”, or “MEA”) typically has a first flow field in fluid communication with the cathode and a second flow field in fluid communication with the anode. The MEA may furthermore be supported on both sides by screen packs or bipolar plates that are disposed within, or that alternatively define, the flow fields. Screen packs or bipolar plates may facilitate fluid movement to and from the MEA, membrane hydration, and may also provide mechanical support for the MEA.

In order to maintain intimate contact between cell components under a variety of operational conditions and over long time periods, uniform compression may be applied to the cell components. Pressure pads or other compression means are often employed to provide even compressive force from within the electrochemical cell.

While existing internal components are suitable for their intended purposes, there still remains a need for improvement, particularly regarding cell efficiency at lower cost, weight and size. Accordingly, a need exists for improved internal cell components of an electrochemical cell, and particularly bipolar plates, that can operate at sustained high pressures, while offering a low profile configuration.

### BRIEF DESCRIPTION OF THE INVENTION

A bipolar plate for an electrochemical cell having a membrane-electrode-assembly (MEA) and capable of operating at a pressure difference across the MEA is provided. The bipolar plate includes an electrically conductive unitary plate having a first surface on one side of the unitary plate, a second surface on an opposing side of the unitary plate, and a plurality of ports in fluid communication with at least one of the first and second surfaces. A first plurality of protrusions extends from the first surface of the unitary plate. The first plurality of protrusions forms a first plurality of channels that extends in a first direction and are arranged to communicate a fluid from one side of the unitary plate to the other. The first plurality of channels may have varied effective lengths.

An electrochemical cell is also provided having a membrane-electrode-assembly (MEA). A first bipolar plate is in electrical contact with a first side of the MEA and a second bipolar plate is in electrical contact with a second side of the MEA. Wherein the first and second bipolar plates are each comprised of a unitary plate having a first surface with a first inlet port and a first outlet port, and a second surface with a second inlet port and a second outlet port. Each of the unitary plate inlet and outlet ports extend through the first and second surfaces. Further, each of the first and second bipolar plates includes a first plurality of protrusions forming a first plurality of flow channels oriented in a first direction on the respective first surface, wherein each of the first plurality of protrusions comprises a support surface sufficient to support the MEA at an operating pressure difference across the MEA of equal to or greater than about 50 pounds-per-square-inch (psi). A first frame is arranged between the first surface of the first bipolar plate and the MEA. The first frame has a first and a second inlet port and a first and a second outlet port. The first frame first inlet port is fluidly coupled to the first bipolar plate first inlet port, and the first frame first outlet port is fluidly coupled to the first bipolar plate first outlet port, wherein the first frame has a first frame inlet header channel at one end of the first plurality of flow channels of the first bipolar plate and in fluid communication with the first frame first inlet port.

### BRIEF DESCRIPTION OF THE DRAWINGS

Referring to the exemplary drawings wherein like elements are numbered alike in the accompanying Figures:

FIG. 1 depicts a schematic diagram of a partial electrochemical cell showing an electrochemical reaction for use in accordance with embodiments of the invention;

FIG. 2 depicts an exploded assembly isometric view of an exemplary electrochemical cell in accordance with embodiments of the invention;

FIG. 3 depicts an exploded assembly section view similar to the assembly of FIG. 2;

FIG. 4 depicts a first side of a unitary bipolar plate in accordance with an embodiment of the invention;

FIG. 5 depicts a cross sectional view of the unitary bipolar plate of FIG. 4;

FIG. 6 depicts a second cross sectional view of the unitary bipolar plate of FIG. 4;

FIG. 7 depicts a second side of the unitary bipolar plate of FIG. 4;

FIG. 8 depicts an alternate embodiment first side view of a unitary bipolar plate;

FIG. 9 depicts another alternate embodiment unitary bipolar plate having non linear flow channels;

FIG. 10 depicts a side view of a portion of an alternate embodiment unitary bipolar plate having inserts;

FIG. 11 depicts a side view of a portion of an alternate embodiment unitary bipolar plate having a single insert; and,

FIG. 12 depicts a first side of an alternate embodiment unitary bipolar plate having channels with different effective lengths.

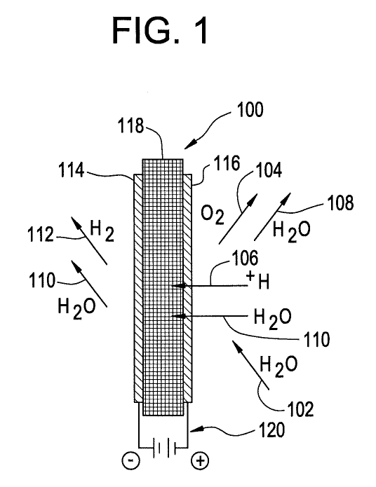

### DETAILED DESCRIPTION OF THE INVENTION

Embodiments of the invention provide a bipolar plate for an electrochemical cell, where the bipolar plate is fabricated from a unitary plate. While embodiments disclosed herein describe chemical etching as an exemplary material-removing process, it will be appreciated that the disclosed invention may also be applicable to other material-removing processes, such as micro-machining, for example.

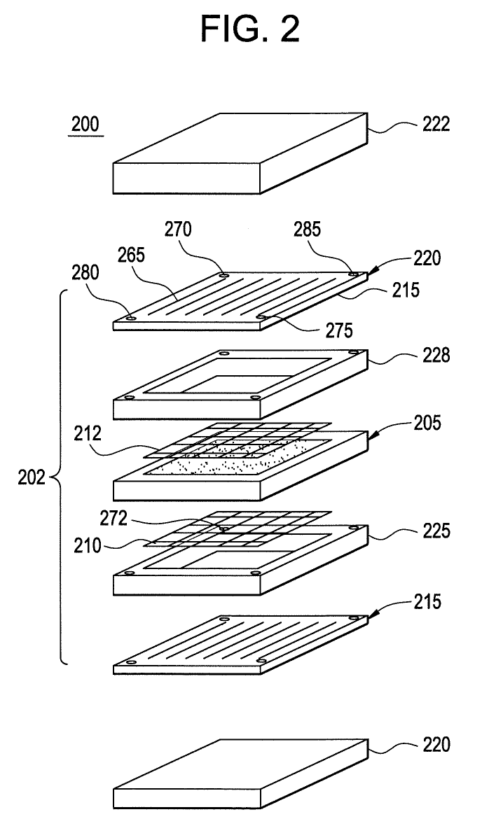

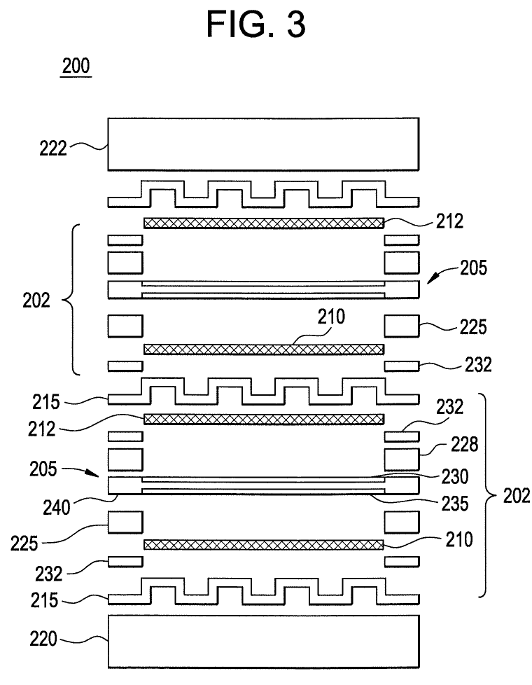

Referring now to FIGS. 2 and 3, an exemplary electrochemical cell stack 200 that may be suitable for operation as an anode feed electrolysis cell, cathode feed electrolysis cell, fuel cell, or regenerative fuel cell is depicted in an exploded assembly isometric view. Thus, while the discussion below may be directed to an anode feed electrolysis cell, cathode feed electrolysis cells, fuel cells, and regenerative fuel cells are also contemplated. Cell stack 200 is typically comprised of a plurality of electrochemical cells 202 (“cells”) employed in the cell stack 200 as part of an electrochemical cell system. When cell 202 is used as an electrolysis cell, power inputs are generally between about 1.48 volts and about 3.0 volts, with current densities between about 50 A/ft² (amperes per square foot) and about 4,000 A/ft². When used as a fuel cells power outputs range between about 0.4 volts and about 1 volt, and between about 0.1 A/ft² and about 10,000 A/ft². The number of cells within the stack, and the dimensions of the individual cells is scalable to the cell power output and/or gas output requirements. Accordingly, application of electrochemical cell stack 200 may involve a plurality of cells 202 arranged electrically either in series or parallel depending on the application. Cells 202 may be operated at a variety of pressures, such as up to or exceeding 50 psi (pounds-per-square-inch), up to or exceeding about 100 psi, up to or exceeding about 500 psi, up to or exceeding about 2500 psi, or even up to or exceeding about 10,000 psi, for example. Endplates 220, 222 are arranged and coupled to the cells 202 to provide the necessary electrical power and management of the fluids into and out of the cell stack 200.

In an embodiment, cell 202 includes a membrane-electrode-assemblies (MEAs) 205 alternatively arranged with a plurality of flow field member 210 between a first cell bipolar separator plate 215 and a second cell bipolar separator plate 215. A frame 225 is arranged between the first bipolar plate 215 and the MEA 205. Similarly, a second frame 228 is arranged between the second bipolar plate 215 and the MEA 205. Both of the frames 225, 228 include a generally hollow center portion that is sized to receive cell components such as flow fields 210, 212. The flow field 210 may be a sintered metal porous plate that is sized to support the MEA 205 under pressure for example. The flow field 212 may be a stack of screen material for example. Gaskets 232 may be included between the components to provide the necessary sealing to prevent leakage of fluids or gases. It should be appreciated that the cell stack 200 may also include other components typically found in electrochemical cells such as but not limited to pressure pads.

MEA 205 has a first electrode (e.g., cathode, or hydrogen electrode) 230 and a second electrode (e.g., anode, or oxygen electrode) 235 disposed on opposite sides of a proton exchange membrane (membrane) 240, best seen by referring to FIG. 3. Bipolar plates 215, which are in fluid communication with electrodes 230, 235 of an adjacent MEA 205, have a structure, to be discussed in more detail below, that define channels adjacent to electrodes 230 and 235. The cell components, particularly cell stack end plates (also referred to as manifolds) 220, 222, bipolar plates 215, and gaskets 232 may be formed with suitable manifolds or other conduits for fluid flow.

In an embodiment, membrane 240 comprises electrolytes that are preferably solids or gels under the operating conditions of the electrochemical cell. Useful materials include proton conducting ionomers and ion exchange resins. Useful proton conducting ionomers include complexes comprising an alkali metal salt, alkali earth metal salt, a protonic acid, or a protonic acid salt. Useful complex-forming reagents include alkali metal salts, alkaline metal earth salts, and protonic acids and protonic acid salts. Counter-ions useful in the above salts include halogen ion, perchloric ion, thiocyanate ion, trifluoromethane sulfonic ion, borofluoric ion, and the like. Representative examples of such salts include, but are not limited to, lithium fluoride, sodium iodide, lithium iodide, lithium perchlorate, sodium thiocyanate, lithium trifluoromethane sulfonate, lithium borofluoride, lithium hexafluorophosphate, phosphoric acid, sulfuric acid, trifluoromethane sulfonic acid, and the like. The alkali metal salt, alkali earth metal salt, protonic acid, or protonic acid salt is complexed with one or more polar polymers such as a polyether, polyester, or polyimide, or with a network or cross-linked polymer containing the above polar polymer as a segment. Useful polyethers include polyoxyalkylenes, such as polyethylene glycol, polyethylene glycol monoether, and polyethylene glycol diether; copolymers of at least one of these polyethers, such as poly(oxyethylene-co-oxypropylene) glycol, poly(oxyethylene-co-oxypropylene) glycol monoether, and poly(oxyethylene-co-oxypropylene) glycol diether; condensation products of ethylenediamine with the above polyoxyalkylenes; and esters, such as phosphoric acid esters, aliphatic carboxylic acid esters or aromatic carboxylic acid esters of the above polyoxyalkylenes. Copolymers of, e.g., polyethylene glycol with dialkylsiloxanes, maleic anhydride, or polyethylene glycol monoethyl ether with methacrylic acid are known in the art to exhibit sufficient ionic conductivity to be useful.

Ion-exchange resins useful as proton conducting materials include hydrocarbon- and fluorocarbon-type resins. Hydrocarbon-type ion-exchange resins include phenolic resins, condensation resins such as phenol-formaldehyde, polystyrene, styrene-divinyl benzene copolymers, styrene-butadiene copolymers, styrene-divinylbenzene-vinylchloride terpolymers, and the like, that are imbued with cation-exchange ability by sulfonation, or are imbued with anion-exchange ability by chloromethylation followed by conversion to the corresponding quaternary amine.

Fluorocarbon-type ion-exchange resins may include hydrates of tetrafluoroethylene-perfluorosulfonyl ethoxyvinyl ether or tetrafluoroethylene-hydroxylated (perfluoro vinyl ether) copolymers. When oxidation and/or acid resistance is desirable, for instance, at the cathode of a fuel cell, fluorocarbon-type resins having sulfonic, carboxylic and/or phosphoric acid functionality are preferred. Fluorocarbon-type resins typically exhibit excellent resistance to oxidation by halogen, strong acids and bases. One family of fluorocarbon-type resins having sulfonic acid group functionality is NAFION resins (commercially available from E. I. du Pont de Nemours and Company, Wilmington, Del.).

Electrodes 230 and 235 may comprise a catalyst suitable for performing the needed electrochemical reaction (i.e., electrolyzing water and producing hydrogen). Suitable catalyst include, but are not limited to, materials comprising platinum, palladium, rhodium, carbon, gold, tantalum, tungsten, ruthenium, iridium, osmium, alloys of at least one of the foregoing catalysts, and the like. Electrodes 230 and 235 may be formed on membrane 240, or may be layered adjacent to, but in contact with, membrane 240.

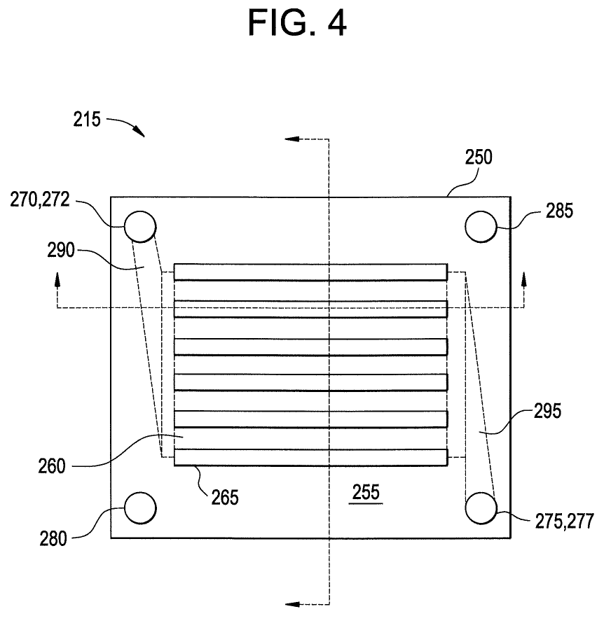

In an embodiment, and referring now to FIGS. 2-4, bipolar plate 215 is made from a unitary plate 250 of titanium, zirconium, stainless steel, or any other material found to be suitable for the purposes disclosed herein, such as niobium, tantalum, carbon steel, nickel, cobalt, and associated alloys, for example. FIG. 4 depicts a first surface 255 (front side view) of the unitary plate 250 having a first plurality of flow channels 260 formed by a plurality of protrusions 265 that extend from the first surface 255 oriented in a first direction. The protrusions 265 are sized to provide support for field flow member 210 and in turn MEA 205. In one embodiment, the first surface includes 21 protrusions having a width of 0.093 inches and spaced 0.093 inches apart. In this embodiment, the protrusions have a height equal to 1× the material thickness of bipolar plate 215, 0.020-0.060 inches for example. The protrusions 265 on the first surface 255 may be formed by any suitable method including machining, stamping or chemical etching.

The first surface also includes a first inlet port 270 that communicates with a first inlet port 272 in first frame 225. A first header channel 290 in first frame 225 allows fluid communication between the first inlet port 272 and the flow channels 260. A first outlet port 275 in the first surface 255 is coupled to an outlet port 277 in the first frame 225. A first outlet header 295 in first frame 225 provides fluid communication from the channels 260 to the outlet port 277. The first surface 255 further includes a second inlet port 280 and second outlet port 285 as will be described in more detail below.

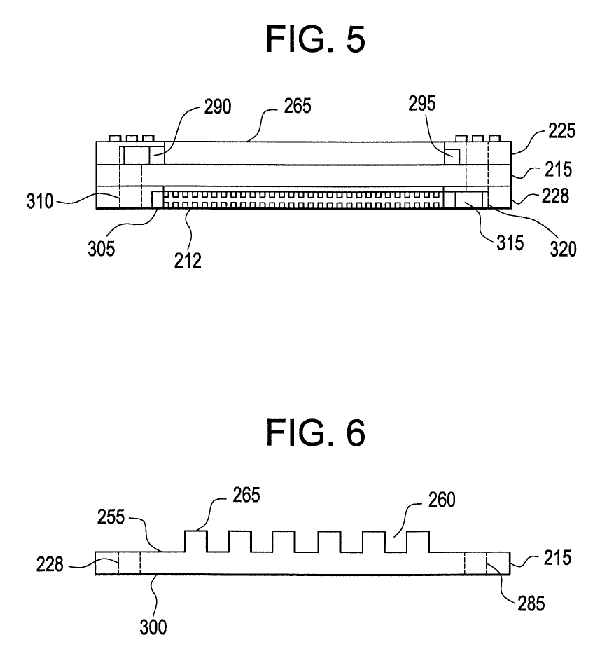

In one embodiment, the second surface 300 of bipolar plate 225 is flat as shown in FIG. 5 and FIG. 6. In this embodiment, a flow field member, such as screen pack 212 for example, provides the fluid communication between the MEA 205 (as shown in FIG. 3) and a second inlet header 305 located in second frame 228. Second inlet header 305 provides fluid communication between the internal portion of the cell and second inlet port 310 in the second frame 228. The second inlet port 310 is coupled to the second inlet port 280 (shown in FIG. 4) in bipolar plate 215. Similarly, a second outlet header 315 arranged in second frame 228 provides fluid communication to a second outlet port 320. Second outlet 320 is coupled to outlet port 285 in bipolar plate 215.

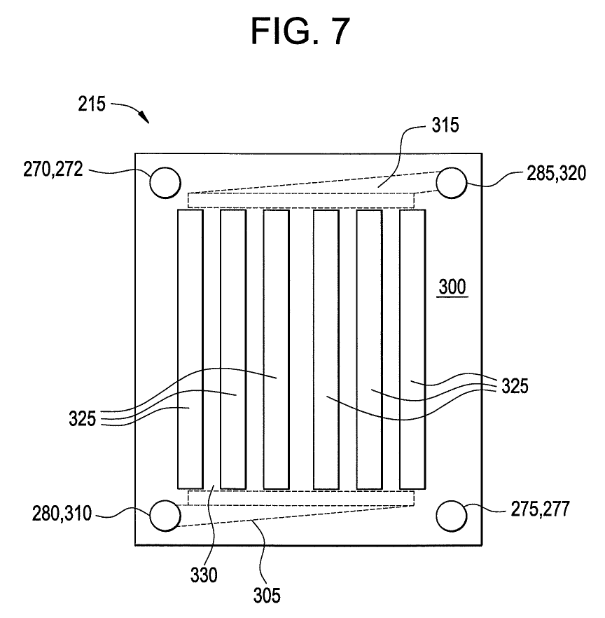

Alternatively, second surface 300 may include a second plurality of protrusions 325 as shown in FIG. 7. The protrusions 325 form a plurality of channels 330 that provide fluid communication between second inlet header 305 and second outlet header 315. In one embodiment, the first surface includes 21 protrusions having a width of 0.093 inches and spaced 0.093 inches apart. In this embodiment, the protrusions have a height equal to 1× the material thickness of bipolar plate 215, 0.020-0.060 inches for example. The protrusions 325 on the second surface 300 may be formed by any suitable method including machining, stamping or chemical etching.

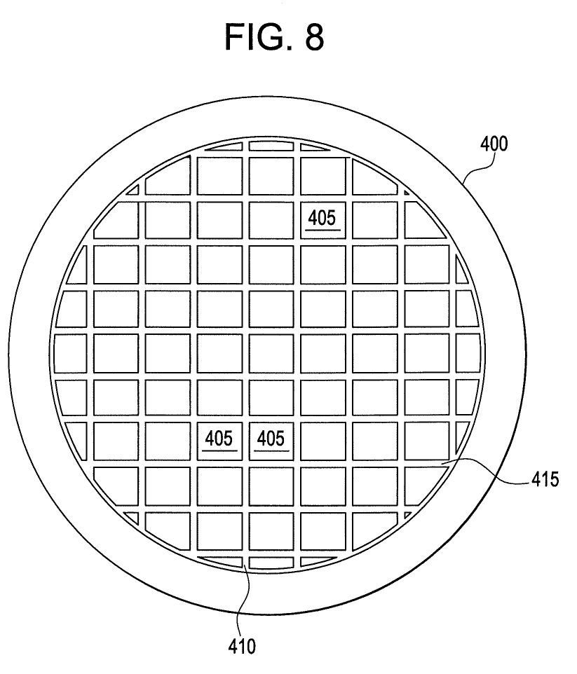

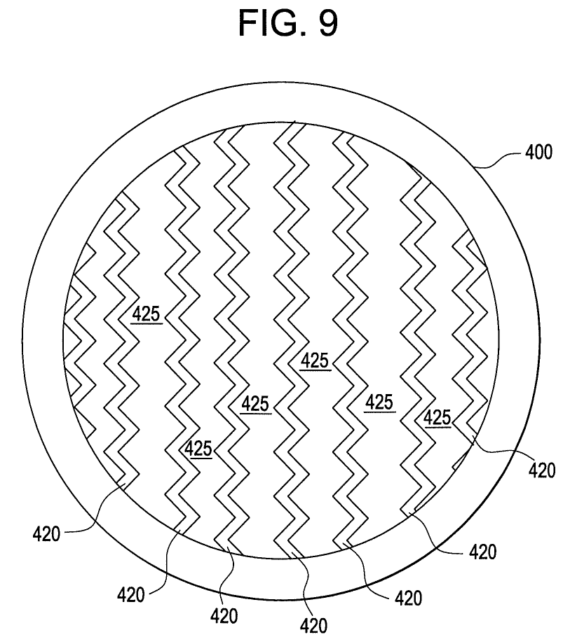

The forming of protrusions and channels in is not limited to straight parallel rows or to rectangular shaped cell stack 200 components as shown in FIGS. 2 and 3. An alternate embodiment of a cell stack having a circular frame 400 is illustrated in FIG. 8. In this embodiment, the protrusions 405 form intersecting rows of channels 410, 415 to provide a broad distribution of fluid flow to the MEA 205. Referring to FIG. 9, an alternate nonparallel embodiment utilizes protrusions 425 that form non-straight rows 420, such as zig-zag for example. This embodiment may provide advantages in supporting the flow field member 210, such as a porous plate for example, and prevent deformation.

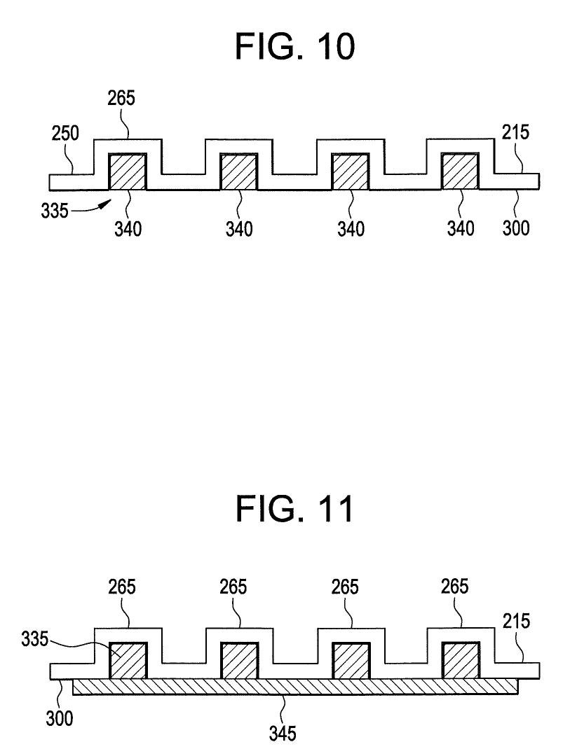

In another alternate embodiment shown in FIG. 10, the bipolar plate 215 is formed from a stamped sheet material. In this embodiment, the protrusions 265 formed during the stamping process include a corresponding recess 335 in the opposite surface 300. In some applications, it may be desirous to provide continuous support for the MEA 205, in this embodiment an insert 340 is sized to fit within the recess 335. The insert 340 may be an electrically conductive material such as titanium, zirconium, stainless steel, or any other material found to be suitable for the purposes disclosed herein, such as niobium, tantalum, carbon steel, nickel, cobalt, and associated alloys, for example. Alternatively, the insert may be nonconductive such as a rubber or a polymer material for example.

Rather than individual inserts, the inserts may be formed as a single support insert 345 to facilitate the filling of recess 335 as shown in FIG. 11. In this embodiment, the insert 345 would be formed from an electrically conductive material to allow the electrical circuit needed for electrolysis to be completed. The material may be titanium, zirconium, stainless steel, or any other material found to be suitable for the purposes disclosed herein, such as niobium, tantalum, carbon steel, nickel, cobalt, and associated alloys, for example.

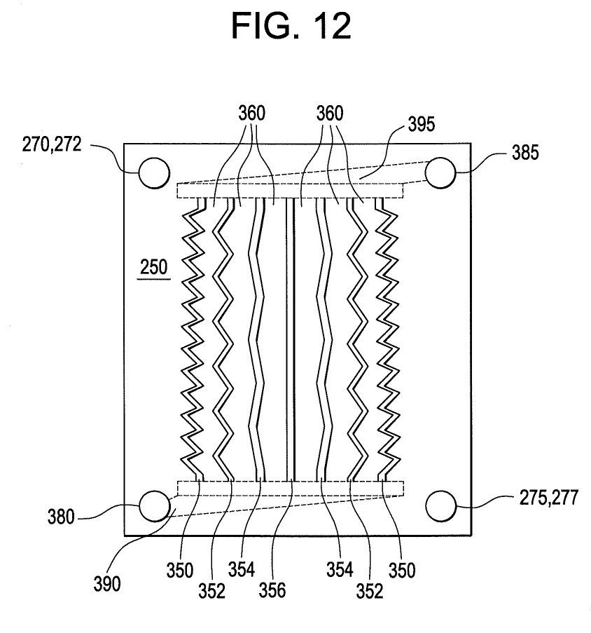

In the embodiments discussed above, the inlet port and the outlet port from a cell 202 are located diagonally from each other across the bipolar plate 215. This arrangement may result in uneven flow within the channels since the pressure at the channels closer to the inlet port will be higher, and thus will have higher flow. To accommodate this difference in pressures, an alternate embodiment is shown in FIG. 12. In this embodiment, a series of channels 350, 352, 354, 356 are formed by protrusions 360 on a unitary plate 250. A first inlet header 390 provides fluid communication from a first inlet port 380 to each of the channels. A first outlet header 395 provides fluid communication from the channels 350, 352, 354, 356 to first outlet port 385. The channels are arranged such that the channel 350 that is closest to the edge of the bipolar plate 215 has a longer effective length L1 than adjacent channel 352 that has an effective length of L2. The effective length of the channels decreases progressively until the channel in the center 356 which has the shortest effective length L3. The channels then proceed to increase in effective length again as the channels continue to proceed to the end of the header channel 390 opposite the inlet port 380 with the farthest channel 350 having an effective length L1.

To increase the effective length of the channels, each channel 350, 352, 354 has a different profile. In the exemplary embodiment, the center channel 356, is straight to provide the shorted path between the inlet header channel and the outlet header channel. The channel 350, 351, 354 may be saw-toothed in shape as illustrated in FIG. 12, or alternatively may have a smoother curved profile. By increasing the effective length, the rate of flow across the bipolar plate should be more uniform when compared with a bipolar plate having straight parallel channels. It should be appreciated that the effective lengths and shapes used to achieve these effective lengths will vary depending on the operating parameters of the cell stack 200.

As disclosed, some embodiments of the invention may include some of the following advantages: a low cost, compact, light weight bipolar plate that may be fabricated by low cost manufacturing methods to provide a low profile electrochemical cell arrangement; a unitary bipolar plate suitable for operating within an electrochemical cell at pressure differentials in excess of 50 psi, where the cell may operate as a low-pressure electrolysis cell, which has a typical operating pressure on the order of 200 psi or higher, or a high-pressure fuel cell, which has a typical operating pressure on the order of 20 psi or lower; and, a unitary bipolar plate arrangement that may have complex flow features and/or paths chemically etched or micro-machined onto each side.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A bipolar plate for an electrochemical cell having a membrane-electrode-assembly (MEA) and capable of operating at a pressure difference across the MEA, the bipolar plate comprising:
an electrically conductive unitary plate having a first surface on one side of said unitary plate, a second surface on an opposing side of said unitary plate, and a plurality of ports in fluid communication with at least one of the said first and said second surfaces;
a first plurality of protrusions extending from said first surface of said unitary plate, said first plurality of protrusions forming a first plurality of channels that extend in a first direction and are arranged to communicate a fluid from one side of said unitary plate to the other, the first plurality of channels having varied effective lengths.

2. The bipolar plate of claim 1, wherein said second surface further includes a second plurality of protrusions from said second surface, said second plurality of protrusions forming a second plurality of channels that extend in a second direction.

3. The bipolar plate of claim 1, wherein said first plurality of protrusions further form a second set of channels that extend in a second direction.

4. The bipolar plate of claim 1, wherein each of said first plurality of channels has a different length such that the channel closest to the edge of said unitary plate has the longest effective length and a channel in the middle of said unitary plate has the shortest effective length.

5. The bipolar plate of claim 4, wherein said middle channel is straight.

6. The bipolar plate of claim 5, wherein said unitary plate further includes a second plurality of protrusions extending from said first surface of said unitary plate, said second plurality of protrusions forming a second plurality of channels that extend in said first direction and are arranged to communicate a fluid from one side of said unitary plate to the other.

7. The bipolar plate of claim 6, wherein said second plurality of channels mirror said first plurality of channels about a plane that extends perpendicular to said first surface and is centered on said middle channel.

8. The bipolar plate of claim 1, wherein:
said unitary plate is made from titanium, zirconium, stainless steel, or any combination comprising at least one of the foregoing materials.

9. The bipolar plate of claim 1, wherein each of said first plurality of protrusions comprises a support surface sufficient to support the MEA at an operating pressure difference across the MEA of equal to or greater than about 100 psi.

10. An electrochemical cell, comprising:
a membrane-electrode-assembly (MEA), a first bipolar plate in electrical contact with a first side of said MEA and a second bipolar plate in electrical contact with a second side of said MEA;
wherein said first and second bipolar plates are each comprised of a unitary plate having a first surface with a first inlet port and a first outlet port, and a second surface with a second inlet port and a second outlet port, each of said inlet and said outlet ports extending through said first and second surfaces;
each of said first and second bipolar plates further include a first plurality of protrusions forming a first plurality of flow channels oriented in a first direction on the respective first surface wherein each of said first plurality of protrusions comprises a support surface sufficient to support said MEA at an operating pressure difference across the MEA of equal to or greater than about 50 pounds-per-square-inch (psi); and,
a first frame between said first surface of said first bipolar plate and said MEA, said first frame having said first and said second inlet ports and said first and said second outlet ports, wherein said first frame first inlet port is fluidly coupled to said first bipolar plate first inlet port, and said first frame first outlet port is fluidly coupled to said first bipolar plate first outlet port, wherein said first frame has a first frame inlet header channel at one end of the said first plurality of flow channels of said first bipolar plate and in fluid communication with said first frame first inlet port.

11. The electrochemical cell of claim 10, wherein said first frame further includes a first outlet header channel at the other end of said first plurality of channels and in fluid communication with said first frame first outlet port.

12. The electrochemical cell of claim 11 further comprising a second plurality of protrusions forming a second plurality of flow channels oriented in a second direction on said second surface wherein each of said second plurality of protrusions comprises a support surface sufficient to support the MEA at an operating pressure difference across the MEA of equal to or greater than about 50 pounds-per-square-inch (psi).

13. The electrochemical cell of claim 12 further comprising a second frame between said second bipolar plate second surface and said MEA, said second frame having a first and second inlet ports and a first and second outlet ports, said second frame further having a second frame inlet header channel fluidly coupled to said second inlet port, wherein said second frame second inlet port is fluidly coupled to said second bipolar plate second inlet port and said second frame second outlet port is fluidly coupled to said second bipolar plate second outlet port, and said second frame inlet header channel is arranged at one end of said second plurality of channels.

14. The electrochemical cell of claim 13 wherein said second frame further includes an outlet header channel at the other end of the second plurality of channels and in fluid communication with said second frame second outlet port.

15. The electrochemical cell of claim 14 wherein:
said first direction is oriented about 90 degrees to said second direction;
said first frame first inlet port and said first frame first outlet port are diagonally disposed with respect to a fluid flow therebetween; and
said second frame second inlet port and said second frame second outlet port are diagonally disposed with respect to a fluid flow therebetween.

16. The electrochemical cell of claim 12 wherein said first plurality of channels is comprised of a first set of channels adjacent to said first inlet port and a second set of channels adjacent to said first outlet port, wherein each of said channels in said first set of channels has a different length.

17. The electrochemical cell of claim 16 wherein a first channel in said first set of channels adjacent to said first inlet port has a longer length than a second channel in said first set of channels that is adjacent to and opposite said first inlet port.

18. The electrochemical cell of claim 17 wherein the length of each channels in said first set of channels decreases as said channels are positioned farther from said first inlet port.

19. The electrochemical cell of claim 12 further comprising a first flow field member disposed in between said second plurality of protrusions and said MEA.

20. The electrochemical cell of claim 19 wherein said first flow field member is a porous plate.
